(19) United States
(12) Patent Application Publication
(10) Pub. No.: US 2025/0308111 A1
(43) Pub. Date: Oct. 2, 2025

(54) System and Method for Artificial Intelligence (AI)-Based Interactive Virtual Asset Composition

(71) Applicants: Sony Interactive Entertainment LLC, San Mateo, CA (US); Sony Interactive Entertainment Inc., Tokyo (JP)

(72) Inventors: Bethany Tinklenberg, San Mateo, CA (US); Tatianna Forget, San Mateo, CA (US); Mahdi Azmandian, San Mateo, CA (US)

(21) Appl. No.: 18/617,567

(22) Filed: Mar. 26, 2024

(51) Int. Cl. G06T 11/60; G06F 3/04845

(52) U.S. Cl. CPC G06T 11/60; G06F 3/04845; G06T 2200/24

(57) ABSTRACT

A base image is generated by an artificial intelligence (AI)-based image generation system based on a user-specified input specification. An AI-based image layer extraction system automatically identifies and extracts a plurality of layers of graphical content within the base image into a corresponding plurality of pre-layer images. An AI-based image auto-complete system automatically completes each of the plurality of pre-layer images into a corresponding plurality of full-layer images respectively corresponding to the plurality of layers of graphical content within the base image. A layer editing workbench controller provides for display and user-directed editing of a selected one or more of the plurality of full-layer images. An AI-based composite image generator automatically combines the plurality of full-layer images as edited by the layer editing workbench controller into a composite image.

### BACKGROUND OF THE INVENTION

The video game industry has seen many changes over the years and has been trying to find ways to enhance the video game play experience for players and increase player engagement with the video games and/or online gaming systems, which ultimately leads to increased revenue for the video game developers and providers and the video game industry in general. Artificial intelligence (AI) is being utilized more in the development of video game content. It is within this context that implementations of the present disclosure arise.

### SUMMARY OF THE INVENTION

In an example embodiment, a system for AI-based interactive virtual asset composition is disclosed. The system includes an input processor configured to receive an input specification for AI-based image generation. The system also includes an AI-based image generation system configured to generate a base image based on the input specification. The system also includes an AI-based image layer extraction system configured to automatically identify a plurality of layers of graphical content within the base image. The AI-based image layer extraction system is configured to automatically extract each of the plurality of layers of graphical content into a corresponding pre-layer image, so as to generate a plurality of pre-layer images respectively corresponding to the plurality of layers of graphical content within the base image. The system also includes an AI-based image auto-complete system configured to automatically complete each of the plurality of pre-layer images into a corresponding full-layer image, so as to generate a plurality of full-layer images respectively corresponding to the plurality of layers of graphical content within the base image. The system also includes a layer editing workbench controller configured to provide a user interface for display and editing of a selected one of the plurality of full-layer images. The system also includes an AI-based composite image generator configured to automatically combine the plurality of full-layer images as edited by the layer editing workbench controller into a composite image.

In an example embodiment, a method is disclosed for AI-based interactive virtual asset composition. The method includes receiving an input specification for AI-based image generation. The method also includes executing an AI-based image generation system to generate a base image based on the input specification. The method also includes executing an AI-based image layer extraction system to automatically identify a plurality of layers of graphical content within the base image. The method also includes executing the AI-based image layer extraction system to automatically extract each of the plurality of layers of graphical content into a corresponding pre-layer image, so as to generate a plurality of pre-layer images respectively corresponding to the plurality of layers of graphical content within the base image. The method also includes executing an AI-based image auto-complete system to automatically complete each of the plurality of pre-layer images into a corresponding full-layer image, so as to generate a plurality of full-layer images respectively corresponding to the plurality of layers of graphical content within the base image. The method also includes providing a user interface for display and editing of a selected one of the plurality of full-layer images. The method also includes executing an AI-based composite image generator to automatically combine the plurality of full-layer images as edited through the user interface into a composite image.

### BRIEF DESCRIPTION OF THE DRAWINGS

FIG. 1 shows a diagram of a system for AI-based image generation, in accordance with some embodiments.

FIG. 2 shows an example of the project workbench interface, in accordance with some embodiments.

FIG. 3 shows an example of the layer specification workbench interface, in accordance with some embodiments.

FIG. 4 shows an example of the layer editing workbench interface, in accordance with some embodiments.

FIG. 5 shows an example of the layer adding workbench interface, in accordance with some embodiments.

FIG. 6 shows the project history interface, in accordance with some embodiments.

FIG. 7 shows the layer history interface, in accordance with some embodiments.

FIG. 8 shows a flowchart of a method for AI-based image generation, in accordance with some embodiments.

FIG. 9 shows various components of an example server device within a cloud-based computing system that can be used to perform aspects of the system and methods for AI-based image generation as disclosed herein, in accordance with some embodiments.

### DETAILED DESCRIPTION OF THE INVENTION

In the following description, numerous specific details are set forth in order to provide a thorough understanding of the present disclosure. It will be apparent, however, to one skilled in the art that embodiments of the present disclosure may be practiced without some or all of these specific details. In other instances, well known process operations have not been described in detail in order not to unnecessarily obscure the present disclosure.

Many modern computer applications, such as video games, virtual reality applications, augmented reality applications, virtual world applications, etc., include many images of many different graphics scenes and virtual objects (collectively referred to as virtual assets). For ease of description, the term “computer application” as used herein refers to any type of computer application in which virtual assets are displayed. Also, for ease of description, the term “designer” as used herein refers to a real-world person that engages in the activity of creating virtual assets for display/use in computer applications. Also, for ease of description, the term “user” as used herein refers to a real-world person that utilizes the systems and methods disclosed herein for generating virtual assets. In some embodiments, the user as referred to herein is a designer of virtual assets for use in computer applications.

Virtual assets are created by designers to fit the context of the computer application in which they will be displayed. The virtual assets can be essentially any noun, e.g., any person, place, or thing. The virtual assets can include any number, shape, size, orientation, color, texture, and arrangement of virtual objects. It should be appreciated that there is an essentially limitless number of ways in which any given virtual asset can be imagined, designed, specified, and imaged by a designer. For example, consider a particular context of a particular computer application that calls for display of a virtual asset representing a beach scene. In designing the virtual asset for the beach scene, the designer is tasked with creating many objects having many attributes, such as sand, water, waves, trees, structures, and other any other object that may be present within the beach scene. It should be appreciated that the various options for creation of the beach scene are essentially limitless. The designer is also challenged to create a particular version or instance of a particular virtual asset that coheres with a particular context of the computer application and that satisfies one or more visual objectives. In various embodiments, the visual objectives can include providing visual variety, promoting visual interest, attracting attention, conveying meaning, provoking emotion, inviting contemplation, stimulating user interaction with the computer application, among many other visual objectives. In view of the foregoing, it is of interest to develop automatic and/or semi-automatic ways to assist the designer with the creation of virtual assets for use in computer applications. To this end, various systems and methods are disclosed herein by which a user, e.g., designer, can use AI capabilities to interactively compose virtual assets for use in computer applications.

A significant advancement in graphics design efficiency and computer application time-to-market is possible if the designer is equipped with AI-based tools to provide for automatic and/or semi-automatic creation of various virtual assets for use in the computer application. The systems and methods disclosed herein enable the designer to use AI-based tools to interactively create virtual assets for use in computer applications, e.g., in video games. With the systems and methods disclosed herein, the designer is able to systematically and independently control AI-based generation and refinement of different and separate graphical content within a composite image that is exportable as a virtual asset for use in a computer application. Also, with the systems and methods disclosed herein, the designer is able to track a history of events associated with the AI-based generation and refinement of different and separate graphical content, e.g., of different layers, within the composite image, navigate through the history of events, and revert a current image (virtual asset) composition project to have a selected previously stored graphical content, e.g., layer, within the composite image. In this manner, the systems and methods disclosed herein provide for AI-based automatic generation of virtual assets, AI-based automatic extraction of graphical content layers within the generated virtual assets, and independent user-directed AI-based modification, refinement, and/or addition of separate graphical content layers within the generated virtual asset, with historic graphical content reversion capability.

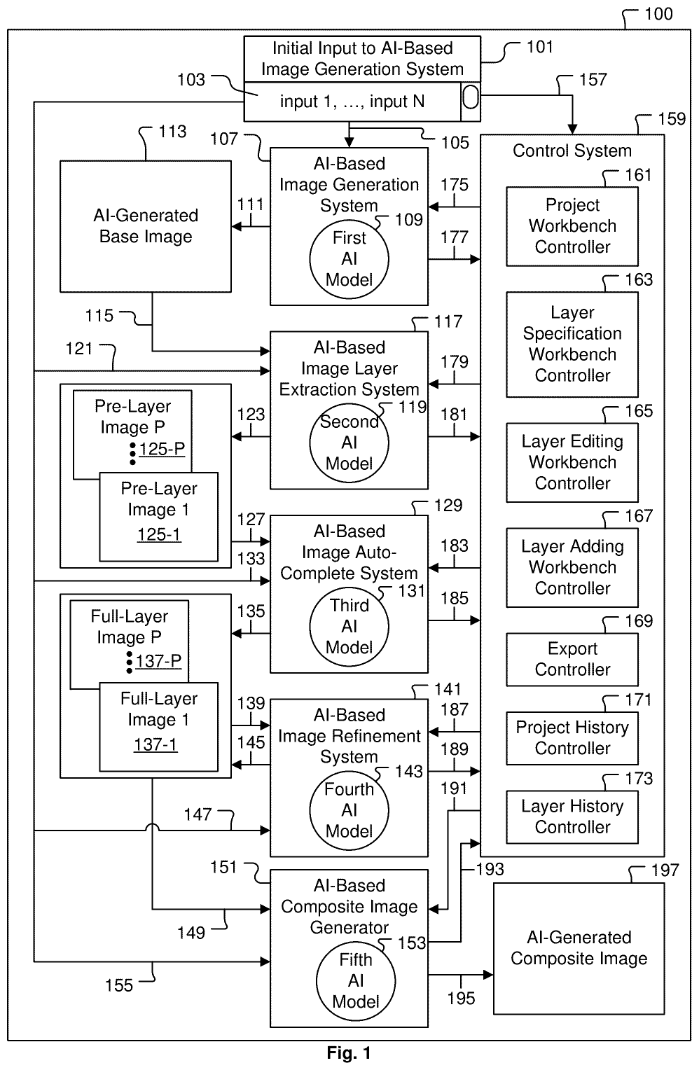

FIG. 1 shows a diagram of a system 100 for AI-based image generation, in accordance with some embodiments. The system 100 includes an input processor 101 configured to receive an input specification 103 for AI-based image generation. The system 100 includes a control system 159 configured to control operation of the system 100. The control system 159 receives the input specification 103 from the input processor 101, as indicated by arrow 157.

The system 100 also includes an AI-based image generation system 107 that includes a first AI model 109 that is configured and trained to generate a base image 113 based on the input specification 103. It should also be understood that the AI-based image generation system 107 is implemented as a combination of rules-based algorithms and the first AI model 109. Also, in some embodiments, the first AI model 109 is implemented as a set of multiple interrelated AI models. The AI-based image generation system 107 receives the input specification 103 from the input processor 101, as indicated by arrow 105. The base image 113 is output by the AI-based image generation system 107, as indicated by arrow 111. In various embodiments, the base image 113 is essentially any graphical image that is displayable on a display screen of a computer system. In various embodiments, the base image 113 is essentially any type of graphical image that displayable by a computer application, such as a video game. The AI-based image generation system 107 is connected in bi-directional communication with the control system 159. More specifically, the AI-based image generation system 107 receives data communications from the control system 159, as indicated by arrow 175, and conveys data communications to the control system 159, as indicated by arrow 177.

The system 100 also includes an AI-based image layer extraction system 117 that includes a second AI model 119 that is configured and trained to automatically identify a plurality of layers of graphical content within the base image 113. The AI-based image layer extraction system 117 receives the base image 113 as an input, as indicated by arrow 115. The second AI model 119 of the AI-based image layer extraction system 117 is also configured and trained to automatically extract each of the identified plurality of layers of graphical content into a corresponding pre-layer image 125-1 to 125-P, where P is an integer greater than one. The AI-based image layer extraction system 117 receives the input specification 103 from the input processor 101, as indicated by arrow 121, to facilitate identification of the plurality of layers of graphical content within the base image 113 and extraction of the identified plurality of layers of graphical content into the corresponding pre-layer images 125-1 to 125-P. In this manner, the AI-based image layer extraction system 117 generates and outputs the plurality of pre-layer images 125-1 to 125-P respectively corresponding to the plurality of layers of graphical content within the base image 113, as indicated by arrow 123. It should also be understood that the AI-based image layer extraction system 117 is implemented as a combination of rules-based algorithms and the second AI model 119. Also, in some embodiments, the second AI model 119 is implemented as a set of multiple interrelated AI models. The AI-based image layer extraction system 117 is connected in bi-directional communication with the control system 159. More specifically, the AI-based image layer extraction system 117 receives data communications from the control system 159, as indicated by arrow 179, and conveys data communications to the control system 159, as indicated by arrow 181. The AI-based image layer extraction system 117 is configured to convey information on a current status of its processing operations to the control system 159, as indicated by arrow 181.

The system 100 also includes an AI-based image auto-complete system 129 that includes a third AI-model 131 that is configured and trained to automatically complete each of the plurality of pre-layer images 125-1 to 125-P into a corresponding full-layer image 137-1 to 137-P. The AI-based image auto-complete system 129 receives the plurality of pre-layer images 125-1 to 125-P as an input, as indicated by arrow 127. The AI-based image auto-complete system 129 receives the input specification 103 from the input processor 101, as indicated by arrow 133, to facilitate automatic completion of each of the plurality of pre-layer images 125-1 to 125-P into the corresponding plurality of full-layer images 137-1 to 137-P. In this manner, the AI-based image auto-complete system 129 generates and outputs the plurality of full-layer images 137-1 to 137-P, as indicated by arrow 135, respectively corresponding to the plurality of pre-layer images 125-1 to 125-P, which respectively correspond to the plurality of layers of graphical content within the base image 113. It should also be understood that the AI-based image auto-complete system 129 is implemented as a combination of rules-based algorithms and the third AI model 131. Also, in some embodiments, the third AI model 131 is implemented as a set of multiple interrelated AI models. The AI-based image auto-complete system 129 is connected in bi-directional communication with the control system 159. More specifically, the AI-based image auto-complete system 129 receives data communications from the control system 159, as indicated by arrow 183, and conveys data communications to the control system 159, as indicated by arrow 185. The AI-based auto-complete system 129 is configured to convey information on a current status of its processing operations to the control system 159, as indicated by arrow 185.

The system 100 also includes an AI-based image refinement system 141 that includes a fourth AI model 143 that is configured to automatically adjust a realism and/or detail level of any one or more of the plurality of full-layer images 137-1 to 137-P in accordance with a relative refinement setting. The AI-based image refinement system 141 receives the plurality of full-layer images 137-1 to 137-P as an input, as indicated by arrow 139. The AI-based image refinement system 141 also receives the input specification 103 from the input processor 101, as indicated by arrow 147, to facilitate automatic refinement of the full-layer images 137-1 to 137-P in accordance with the corresponding relative refinement setting. The AI-based image refinement system 141 outputs refined versions of the plurality of full-layer images 137-1 to 137-P, as indicated by arrow 145. It should also be understood that the AI-based image refinement system 141 is implemented as a combination of rules-based algorithms and the fourth AI model 143. Also, in some embodiments, the fourth AI model 143 is implemented as a set of multiple interrelated AI models. The AI-based image refinement system 141 is connected in bi-directional communication with the control system 159. More specifically, the AI-based image refinement system 141 receives data communications from the control system 159, as indicated by arrow 187, and conveys data communications to the control system 159, as indicated by arrow 189. The AI-based image refinement system 141 is configured to convey information on a current status of its processing operations to the control system 159, as indicated by arrow 189.

The system 100 also includes an AI-based composite image generator 151 that includes a fifth AI model 153 that is configured and trained to automatically combine the plurality of full-layer images 137-1 to 137-P into a composite image 197. The AI-based composite image generator 151 receives the plurality of full-layer images 137-1 to 137-P as an input, as indicated by arrow 149. The AI-based composite image generator 151 also receives the input specification 103 from the input processor 101, as indicated by arrow 155, to facilitate automatic combination of the plurality of full-layer images 137-1 to 137-P into the composite image 197. The AI-based composite image generator 151 outputs the composite image 197, as indicated by arrow 195. It should also be understood that the AI-based composite image generator 151 is implemented as a combination of rules-based algorithms and the fifth AI model 153. Also, in some embodiments, the fifth AI model 153 is implemented as a set of multiple interrelated AI models. The AI-based composite image generator 151 is connected in bi-directional communication with the control system 159. More specifically, the AI-based composite image generator 151 receives data communications from the control system 159, as indicated by arrow 191, and conveys data communications to the control system 159, as indicated by arrow 193. The AI-based composite image generator 151 is configured to convey information on a current status of its processing operations to the control system 159, as indicated by arrow 193.

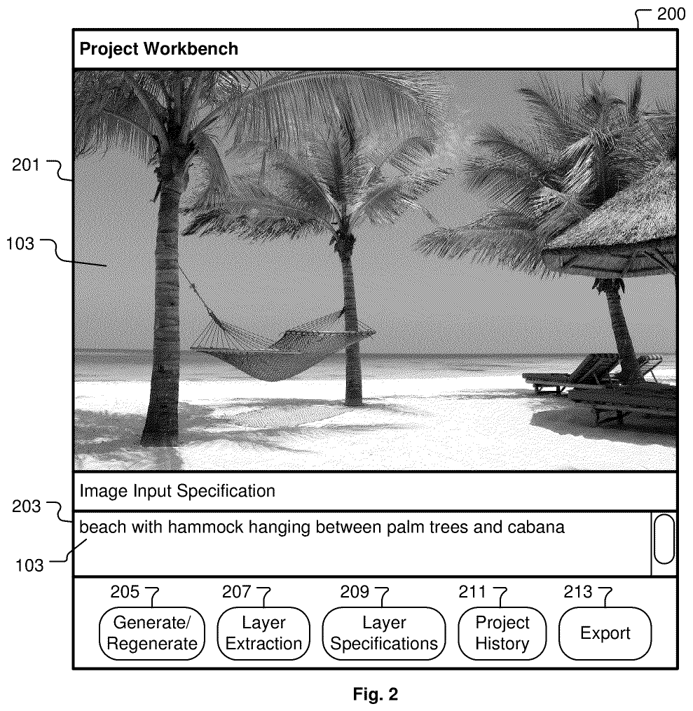

The control system 159 includes a project workbench controller 161 that is configured to generate and display a project workbench interface 200 for user entry of the input specification 103. FIG. 2 shows an example of the project workbench interface 200, in accordance with some embodiments. The project workbench interface 200 includes a display area 201 in which the base image 113, as generated by the AI-based image generation system 107, is displayed. The project workbench interface 200 also includes a control 203 through which the user is able to enter the input specification 103. In some embodiments, the control 203 is a text input field. In some embodiments, the control 203 provides for voice recognition and translation of audible linguistic input into textual input that is shown in the text input field of the control 203. The project workbench interface 200 includes a generate/regenerate control 205 that upon activation directs the AI-based image generation system 107 to generate or regenerate the base image 113 in accordance with a currently entered version of the input specification 103 within the control 203. Upon activation of the generate/regenerate control 205 by the user, the project workbench controller 161 is configured to convey the input specification 103 to the AI-based image generation system 107 and direct generation/regeneration of the base image 113 by the AI-based image generation system 107, as indicated by arrow 175. The project workbench controller 161 is configured to direct display of the base image 113 within the display area 201. The AI-based image generation system 107 is configured to convey information on a current status of its processing operations to the control system 159, as indicated by arrow 177.

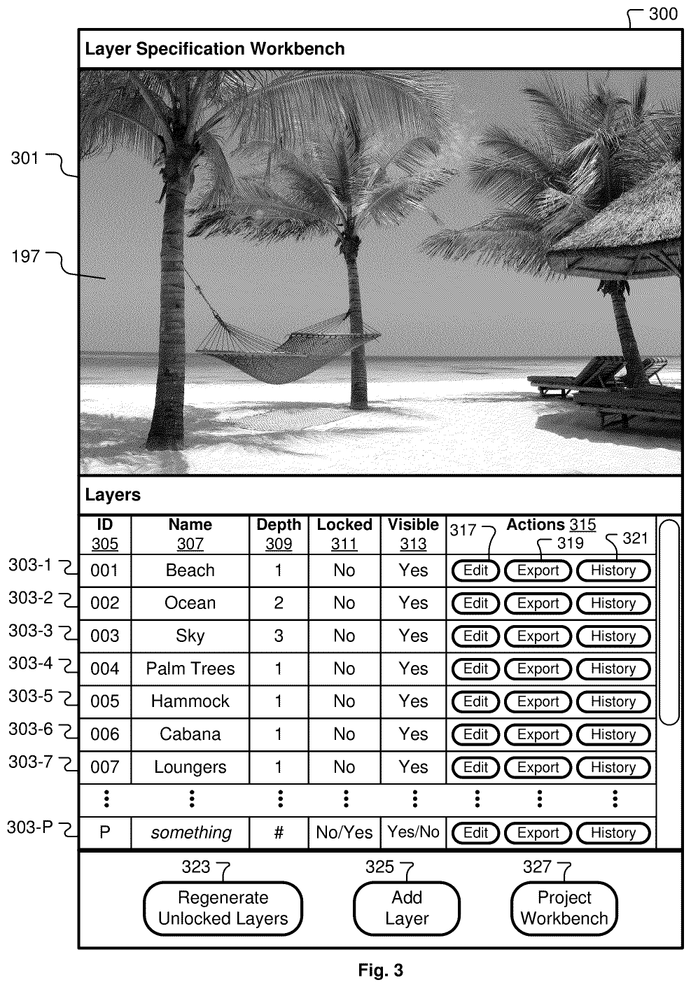

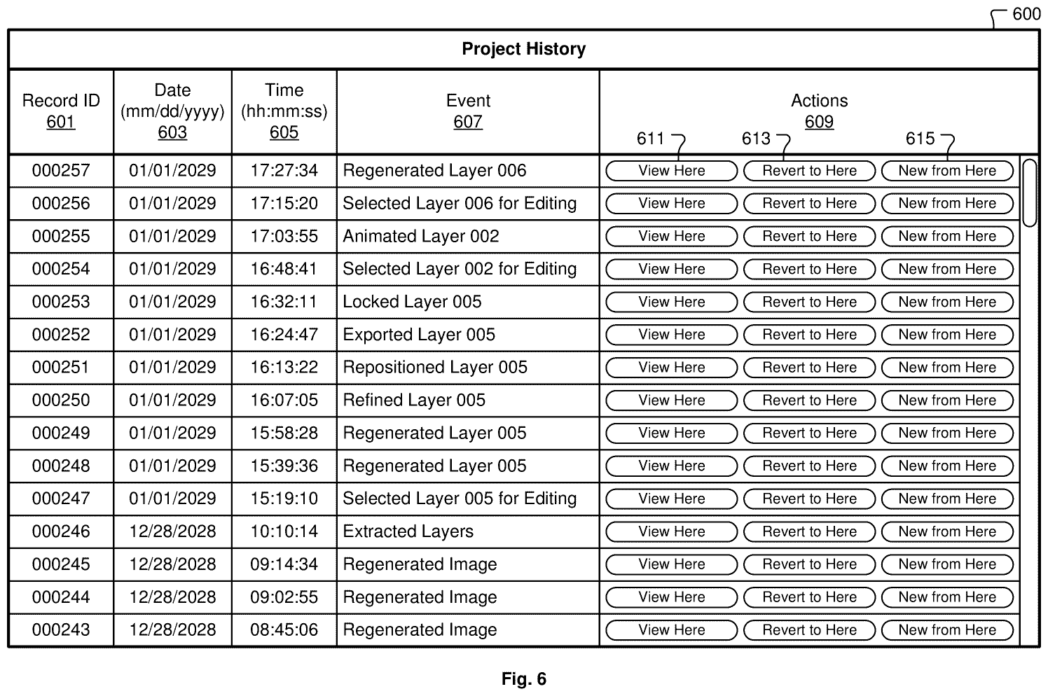

The project workbench interface 200 also includes a layer extraction control 207 that upon activation directs the AI-based image layer extraction system 117 to automatically identify the plurality of layers of graphical content within the base image 113, and automatically extract the identified plurality of layers of graphical content into the respective plurality of pre-layer images 125-1 to 125-P. The project workbench interface 200 also includes a layer specifications control 209 that upon activation directs the system 100 to display a layer specification workbench interface 300, such as shown in FIG. 3. The project workbench interface 200 also includes a project history control 211 that upon activation directs the system 100 to display a project history interface 600, such as shown in FIG. 6. The project workbench interface 200 also includes an export control 213 that upon activation directs the system 100 to export the image currently displayed within the display area 201 to an image file.

The control system 159 also includes a layer specification workbench controller 163 that is configured to generate and display the layer specification workbench interface 300. FIG. 3 shows an example of the layer specification workbench interface 300, in accordance with some embodiments. The layer specification workbench interface 300 includes a display area 301 in which a current version of the composite image 197 is displayed. The current version of the composite image 197 represents a combined display of the plurality of full-layer images 137-1 to 137-P in accordance with their respective layer visibility designations.

The layer specification workbench interface 300 includes a plurality of layer records 303-1 to 303-P respectively corresponding to the plurality of full-layer images 137-1 to 137-P. Each of the plurality of layer records 303-1 to 303-P includes an identifier column 305 in which an identifier number of the layer is shown. Each of the plurality of layer records 303-1 to 303-P includes a name column 307 in which a name of the layer is shown. Each of the plurality of layer records 303-1 to 303-P includes a depth column 309 in which a relative depth number of the layer is shown. The relative depth number of a given layer indicates a predominant visual depth of the given layer within the current version of the composite image 197 relative to the other layers within the plurality of layer records 303-1 to 303-P. In some embodiments, multiple layers within the plurality of layer records 303-1 to 303-P can have the same relative depth number, which means that these multiple layers occupy a similar depth position within the current version of the composite image 197.

Each of the plurality of layer records 303-1 to 303-P also includes a locked designation column 311 in which a lock status of the layer is shown. Each of the plurality of full-layer images 137-1 to 137-P has a locked designation of either “Yes” or “No,” where “Yes” corresponds to the particular full-layer image 137-x being “locked” in the composite image 197, and where “No” corresponds to the particular full-layer image 137-x being “unlocked” in the composite image 197, where x is any integer from 1 to P. The locked designation of each full-layer image 137-x is changeable by the user of the system 100. When a given full-layer image 137-x is “locked,” the given full-layer image 137-x is not modifiable within the current version of the composite image 197. When a given full-layer image 137-x is “unlocked,” the given full-layer image 137-x is available for modification within the current version of the composite image 197, such as through AI-based regeneration and/or refinement of the given full-layer image 137-x and/or by modification of a control parameter, e.g., relative depth, visibility, etc., of the given full-layer image 137-x.

Each of the plurality of layer records 303-1 to 303-P includes a visibility designation column 313 in which the visibility status of the layer is shown. Each of the plurality of full-layer images 137-1 to 137-P has a visibility designation of either “Yes” or “No,” where “Yes” corresponds to the particular full-layer image 137-x being visible in the composite image 197, and where “No” corresponds to the particular full-layer image 137-x not being visible in the composite image 197, where x is any integer from 1 to P. The visibility designation of each full-layer image 137-x is changeable by the user of the system 100.

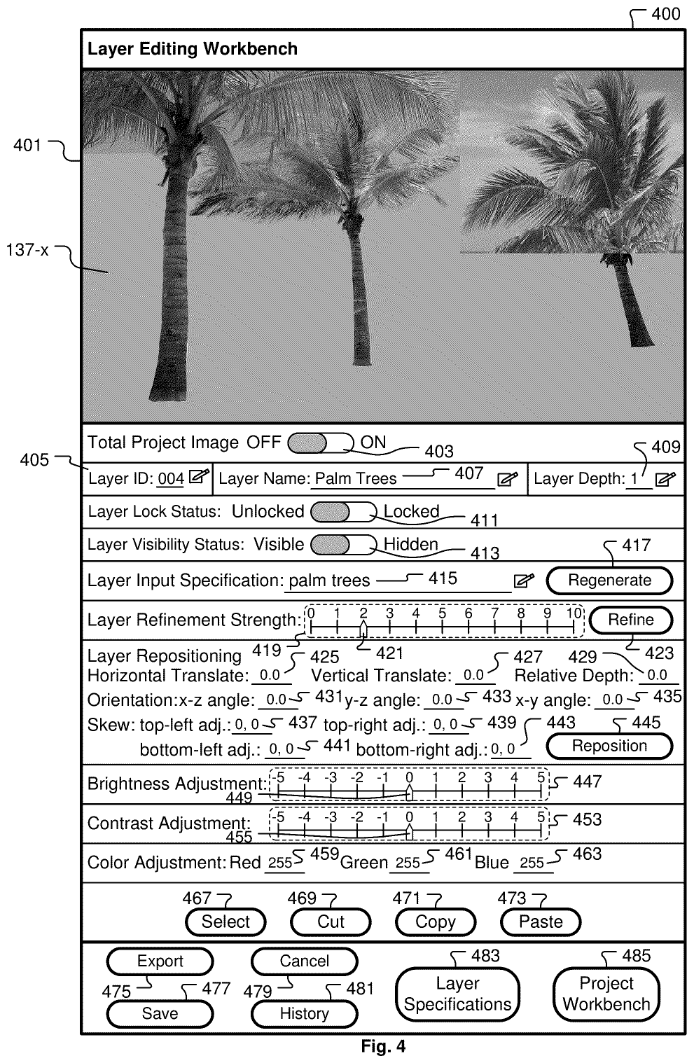

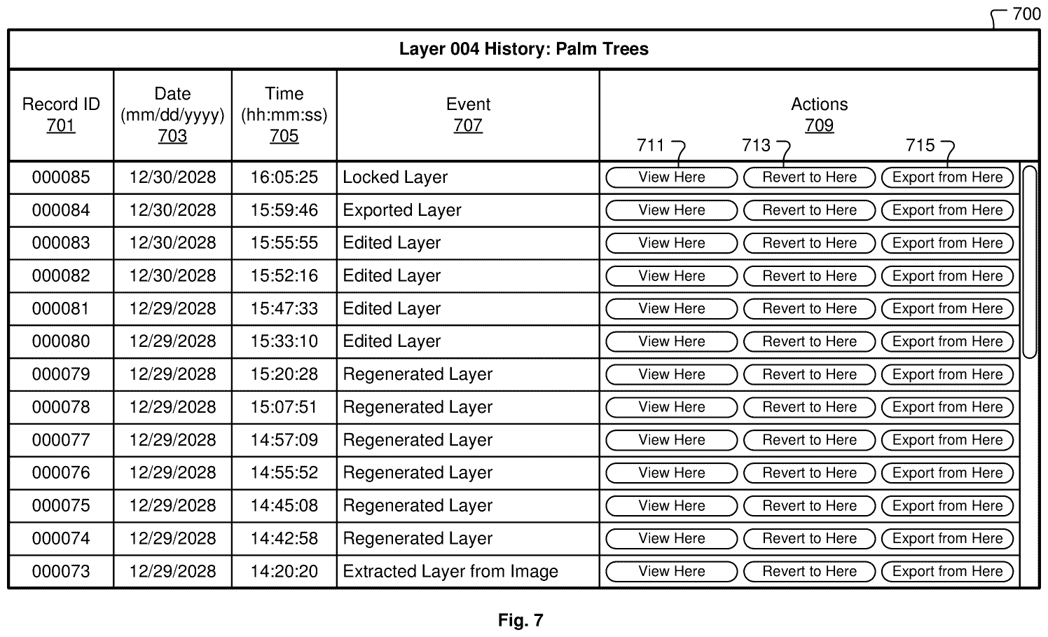

Each of the plurality of layer records 303-1 to 303-P includes an actions column 315, in which a number of controls are provided for directing performance of respective actions with regard to the corresponding layer record 303-1 to 303-P. In the example of FIG. 3, the actions column 315 includes an edit control 317 that when activated by the user for a given layer record 303-x will direct the system 100 to display a layer editing workbench interface 400 for the layer corresponding to given layer record 303-x, such as shown in FIG. 4. Also, in the example of FIG. 3, the actions column 315 includes an export control 319 that when activated by the user for a given layer record 303-x will direct the system 100 to export the full-layer image 137-x corresponding to given layer record 303-x to an image file. Also, in the example of FIG. 3, the actions column 315 includes a layer history control 321 that when activated by the user for a given layer record 303-x will direct the system 100 to display a layer history interface 700 for the layer corresponding to given layer record 303-x, such as shown in FIG. 7.

In some embodiments, the layer specification workbench controller 163 and the layer specification workbench interface 300 enables independent display toggling of each of the plurality of full-layer images 137-1 to 137-P within the composite image 197. Also, in some embodiments, the layer specification workbench controller 163 and the layer specification workbench interface 300 enables independent modification locking of each of the plurality of full-layer images 137-1 to 137-P within the composite image 197. Also, in some embodiments, the layer specification workbench controller 163 and the layer specification workbench interface 300 provides for independent depth specification for each of the plurality of full-layer images 137-1 to 137-P within the composite image 197.

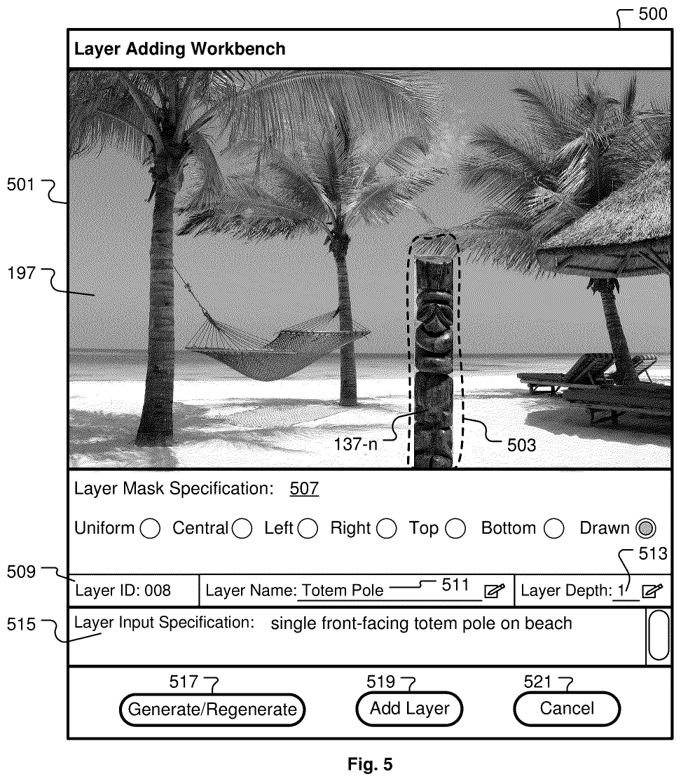

In some embodiments, the layer specification workbench controller 163 and the layer specification workbench interface 300 provides a regeneration control 323 that upon activation directs the AI-based image generation system 107 to regenerate each of the plurality of full-layer images 137-1 to 137-P that is not currently locked. In some embodiments, the layer specification workbench interface 300 includes a project workbench navigation control 327 that when activated by the user directs the system 100 to show the project workbench interface 200 of FIG. 2. Also, in some embodiments, the layer specification workbench interface 300 includes an add layer control 325 that when activated by the user directs the system 100 to show a layer adding workbench interface 500, as shown in FIG. 5.

The control system 159 also includes a layer editing workbench controller 165 that is configured to generate and display the layer editing workbench interface 400. FIG. 4 shows an example of the layer editing workbench interface 400, in accordance with some embodiments. The layer editing workbench interface 400 includes a display area 401 in which a current version of a particular full-layer image 137-x is displayed, where x is an integer from 1 to P. In some embodiments, the particular full-layer image 137-x shown in the display area 401 corresponds to a layer record 303-x within the layer specification workbench interface 300. More specifically, in some embodiments, user activation of the edit control 317 for a particular layer record 303-x within the layer specification workbench interface 300 will direct the system 100 to launch the layer editing workbench interface 400 for the particular full-layer image 137-x corresponding to the particular layer record 303-x. In this manner, the layer editing workbench controller 165 is configured to provide the layer editing workbench interface 400 for display and editing of a selected one of the plurality of full-layer images 137-x.

In some embodiments, the layer editing workbench interface 400 includes a total project image toggle control 403 that when “OFF” will cause only the particular selected full-layer image 137-x to be shown in the display area 401, and that when “ON” will cause the current version of the entire composite image 197 to be shown in the display area 401. In some embodiments, the layer editing workbench controller 165 in combination with the layer editing workbench interface 400 provides for user entry of layer-level data for the particular full-layer image 137-x. More specifically, in some embodiments, a layer identifier field 405 is provided for entry and/or editing of the identifier number of the particular full-layer image 137-x. Also, in some embodiments, a layer name field 407 is provided for entry and/or editing of the name of the particular full-layer image 137-x. Also, in some embodiments, a layer relative depth field 409 is provided for entry and/or editing of the relative predominant depth of the particular full-layer image 137-x within the composite image 197.

In some embodiments, the layer editing workbench interface 400 includes a layer lock status toggle control 411 that when set to “Unlocked” will cause the particular full-layer image 137-x to be unlocked and correspondingly allow for modification of the particular full-layer image 137-x, and that when set to “Locked” will cause the particular full-layer image 137-x to be locked and correspondingly prevent modification of the particular full-layer image 137-x. In some embodiments, the layer editing workbench interface 400 includes a layer visibility status toggle control 413 that when set to “Visible” will cause the particular full-layer image 137-x to be visible within the current version of the composite image 197, and that when set to “Hidden” will cause the particular full-layer image 137-x to not be visible within the current version of the composite image 197.

In some embodiments, the layer editing workbench interface 400 includes a layer input specification 415 through which the user is able to enter and/or update the input specification that is used by the AI-based image generation system 107 to generate and/or regenerate the particular full-layer image 137-x. In some embodiments, the layer editing workbench interface 400 provides for voice recognition and translation of audible linguistic input into textual input that is shown in the layer input specification 415. The layer editing workbench interface 400 includes a regenerate control 417 that upon activation directs the AI-based image generation system 107 to generate and/or regenerate the particular full-layer image 137-x in accordance with the current content of the layer input specification 415. Upon activation of the regenerate control 417 by the user, the layer editing workbench controller 165 conveys the layer input specification 415 to the AI-based image generation system 107 and directs generation/regeneration of a new version of the particular full-layer image 137-x by the AI-based image generation system 107. The layer editing workbench controller 165 is also configured to direct display of the new version of the particular full-layer image 137-x within the display area 401.

The layer editing workbench controller 165 provides a refinement control 423 within the layer editing workbench interface 400 that upon activation directs the AI-based image refinement system 141 to generate a refined version of the selected one of the plurality of full-layer images 137-x in accordance with a current relative refinement setting for the selected one of the plurality of full-layer images 137-x. In some embodiments, the layer editing workbench interface 400 includes a layer refinement strength control 419 for setting of the current relative refinement setting for the selected one of the plurality of full-layer images 137-x. In some embodiments, such as shown in FIG. 4, the layer refinement strength control 419 includes a slider 421 that is moveable by a user along a relative refinement scale, e.g., 0 to 10, to enable user specification of the current relative refinement setting for the selected one of the plurality of full-layer images 137-x. The current relative refinement setting for the selected one of the plurality of full-layer images 137-x is used to adjust a realism and/or detail level of the selected one of the plurality of full-layer images 137-x. For example, in some embodiments, the 0-end of the relative refinement scale corresponds to a lowest amount of realism of the plurality of full-layer images 137-x, and the 10-end of the relative refinement scale corresponds to a greatest amount of realism of the plurality of full-layer images 137-x.

In some embodiments, the layer editing workbench interface 400 and the layer editing workbench controller 165 are configured to provide for adjustment of a position of the particular full-layer image 137-x within the composite image 197. In some embodiments, the layer editing workbench interface 400 includes a horizontal translate control 425 through which the user can specify an amount of horizontal translation, either negative or positive, of the particular full-layer image 137-x within the composite image 197. In some embodiments, the layer editing workbench interface 400 includes a vertical translate control 427 through which the user can specify an amount of vertical translation, either negative or positive, of the particular full-layer image 137-x within the composite image 197. In some embodiments, the layer editing workbench interface 400 includes a relative depth control 429 through which the user can specify an amount of relative depth adjustment, either negative or positive, of the particular full-layer image 137-x within the composite image 197. In some embodiments, the layer editing workbench interface 400 includes a x-z angle orientation control 431 through which the user can specify an amount of rotation within the x-z plane, either negative or positive, of the particular full-layer image 137-x within the composite image 197, where the x-axis is oriented left-to-right in the composite image 197, and where the z-axis is oriented bottom-to-top in the composite image 197. In some embodiments, the layer editing workbench interface 400 includes a y-z angle orientation control 433 through which the user can specify an amount of rotation within the y-z plane, either negative or positive, of the particular full-layer image 137-x within the composite image 197, where the y-axis is orientated front-to-back (in the depth direction) perpendicularly into the composite image 197. In some embodiments, the layer editing workbench interface 400 includes a x-y angle orientation control 435 through which the user can specify an amount of rotation within the x-y plane, either negative or positive, of the particular full-layer image 137-x within the composite image 197.

In some embodiments, the layer editing workbench interface 400 includes a top-left adjustment skew control 437 through which the user can specify an amount of horizontal adjustment, either negative or positive, and an amount of vertical adjustment, either negative or positive, of the top-left corner of the particular full-layer image 137-x within the composite image 197. In some embodiments, the layer editing workbench interface 400 includes a top-right adjustment skew control 439 through which the user can specify an amount of horizontal adjustment, either negative or positive, and an amount of vertical adjustment, either negative or positive, of the top-right corner of the particular full-layer image 137-x within the composite image 197. In some embodiments, the layer editing workbench interface 400 includes a bottom-left adjustment skew control 441 through which the user can specify an amount of horizontal adjustment, either negative or positive, and an amount of vertical adjustment, either negative or positive, of the bottom-left corner of the particular full-layer image 137-x within the composite image 197. In some embodiments, the layer editing workbench interface 400 includes a bottom-right adjustment skew control 443 through which the user can specify an amount of horizontal adjustment, either negative or positive, and an amount of vertical adjustment, either negative or positive, of the bottom-right corner of the particular full-layer image 137-x within the composite image 197. In some embodiments, the layer editing workbench interface 400 includes a reposition control 445 that when activated by the user will cause the current settings of the repositioning inputs, e.g., 425, 427, 429, 431, 433, 435, 437, 439, 441, 443, for the particular full-layer image 137-x to be implemented within the composite image 197 and shown in the display area 401.

In some embodiments, the layer editing workbench interface 400 and the layer editing workbench controller 165 are configured to provide for adjustment of one or more of a brightness, a contrast, and a color of the particular full-layer image 137-x within the composite image 197. In some embodiments, the layer editing workbench interface 400 includes a brightness adjustment control 447 for setting of the brightness of the selected one of the plurality of full-layer images 137-x. In some embodiments, such as shown in FIG. 4, the brightness adjustment control 447 includes a slider 449 that is moveable by a user along a relative brightness scale, e.g.,−5 to 5, to enable user specification of the current brightness setting for the selected one of the plurality of full-layer images 137-x. In some embodiments, the layer editing workbench interface 400 includes a contrast adjustment control 453 for setting of the contrast of the selected one of the plurality of full-layer images 137-x. In some embodiments, such as shown in FIG. 4, the contrast adjustment control 453 includes a slider 455 that is moveable by a user along a relative contrast scale, e.g.,−5 to 5, to enable user specification of the current contrast setting for the selected one of the plurality of full-layer images 137-x.

In some embodiments, the layer editing workbench interface 400 includes a red adjustment control 459 for setting of the red color component of the selected one of the plurality of full-layer images 137-x. In some embodiments, such as shown in FIG. 4, the red adjustment control 459 is a field for entry of numerical value (within a range up to 255) of the red color component. In some embodiments, the layer editing workbench interface 400 includes a green adjustment control 461 for setting of the green color component of the selected one of the plurality of full-layer images 137-x. In some embodiments, such as shown in FIG. 4, the green adjustment control 461 is a field for entry of numerical value (within a range up to 255) of the green color component. In some embodiments, the layer editing workbench interface 400 includes a blue adjustment control 463 for setting of the blue color component of the selected one of the plurality of full-layer images 137-x. In some embodiments, such as shown in FIG. 4, the blue adjustment control 463 is a field for entry of numerical value (within a range up to 255) of the blue color component.

In some embodiments, the layer editing workbench interface 400 provides for manual user editing of the particular full-layer image 137-x shown in the display area 401. In some embodiments, the layer editing workbench interface 400 includes a select control 467 that enables the user to select a region within the particular full-layer image 137-x shown in the display area 401, such as by drawing a line around the region with a cursor. Also, in some embodiments, the layer editing workbench interface 400 includes a cut control 469 that enables the user to cut the selected region from the particular full-layer image 137-x shown in the display area 401. In some embodiments, the AI-based image auto-complete system 129 is engaged to automatically complete the remaining instance of the particular full-layer image 137-x after use of the cut control 469. Also, in some embodiments, the layer editing workbench interface 400 includes a copy control 471 that enables the user to copy the selected region within the particular full-layer image 137-x shown in the display area 401. Also, in some embodiments, the layer editing workbench interface 400 includes a paste control 473 that enables the user to paste the content of the selected region that was previously cut or copied from the particular full-layer image 137-x. In some embodiments, the AI-based image auto-complete system 129 is engaged to automatically incorporate the pasted content of the selection region into the particular full-layer image 137-x after use of the paste control 473.

In some embodiments, the layer editing workbench interface 400 includes an export control 475 that upon activation directs the system 100 to export the image currently displayed within the display area 401 to an image file. In some embodiments, the layer editing workbench interface 400 includes a save control 477 that upon activation directs the system 100 to save the current image composition project that is being worked on within the system 100. In some embodiments, the layer editing workbench interface 400 includes a cancel control 479 that upon activation directs the system 100 to cancel the editing of the particular full-layer image 137-x and revert back to the layer specification workbench interface 300. In some embodiments, the layer editing workbench interface 400 includes a history control 481 that upon activation directs the system 100 to display the layer history interface 700, such as shown in FIG. 7, for the particular full-layer image 137-x shown in the display area 401. In some embodiments, the layer editing workbench interface 400 includes a layer specifications navigation control 483 that upon activation directs the system 100 to display the layer specification workbench interface 300. In some embodiments, the layer editing workbench interface 400 includes a project workbench navigation control 485 that upon activation directs the system 100 to display the project workbench interface 200 of FIG. 2.

With reference to FIG. 1, the control system 159 also includes a layer adding workbench controller 167 that is configured to generate and display the layer adding workbench interface 500. FIG. 5 shows an example of the layer adding workbench interface 500, in accordance with some embodiments. The layer adding workbench interface 500 includes a display area 501 in which the current version of composite image 197 is displayed. In some embodiments, the current version of the composite image 197 shown in the display area 501 corresponds to the current layer visibility specifications specified within the layer specification workbench interface 300. The layer adding workbench controller 167 and the layer adding workbench interface 500 together provide for display and adding of a new full-layer image 137-n to the plurality of full-layer images 137-1 to 137-P.

In some embodiments, the layer adding workbench interface 500 includes a layer input specification field 515 through which the user is able to enter and/or update an input specification that is used by the AI-based image generation system 107 to generate and/or regenerate the new full-layer image 137-n that is to be included within the composite image 197. In some embodiments, the layer adding workbench interface 500 provides for voice recognition and translation of audible linguistic input into textual input that is shown in the layer input specification field 515. The layer adding workbench interface 500 includes a generate/regenerate control 517 that upon activation directs the AI-based image generation system 107 to generate and/or regenerate the new full-layer image 137-n in accordance with the current content of the layer input specification field 515. Upon activation of the generate/regenerate control 517 by the user, the layer adding workbench controller 167 conveys the layer input specification 515 to the AI-based image generation system 107 and directs generation/regeneration of the new full-layer image 137-n by the AI-based image generation system 107. The layer adding workbench controller 167 is also configured to direct display of the new full-layer image 137-n within the display area 501.

In some embodiments, the layer adding workbench controller 167 and the layer adding workbench interface 500 together provide for user entry of a layer mask specification 507 to spatially control implementation of the new full-layer image 137-n within the composite image 197. In some embodiments, the layer mask specification 507 includes a uniform selection that when selected will cause the new full-layer image 137-n to be implemented in a substantially uniform manner across the composite image 197. In some embodiments, the layer mask specification 507 includes a central selection that when selected will cause the new full-layer image 137-n to be implemented in a substantially centrally positioned manner within the composite image 197, e.g., within a region near the center of the composite image 197. In some embodiments, the layer mask specification 507 includes a left selection that when selected will cause the new full-layer image 137-n to be implemented substantially within the left half of the composite image 197. In some embodiments, the layer mask specification 507 includes a right selection that when selected will cause the new full-layer image 137-n to be implemented substantially within the right half of the composite image 197. In some embodiments, the layer mask specification 507 includes a top selection that when selected will cause the new full-layer image 137-n to be implemented substantially within the top half of the composite image 197. In some embodiments, the layer mask specification 507 includes a bottom selection that when selected will cause the new full-layer image 137-n to be implemented substantially within the bottom half of the composite image 197. In some embodiments, the layer mask specification 507 includes a drawn selection that when selected will cause the new full-layer image 137-n to be implemented substantially within a region drawn by the user within the composite image 197, such as by drawing a line around the region with a cursor. FIG. 5 shows an example region 503 drawn for inclusion of the new full-layer image 137-n of a “single front-facing totem pole on beach” within the composite image 197.

In some embodiments, a layer identifier field 509 is provided for entry and/or editing of the identifier number of the new full-layer image 137-n. Also, in some embodiments, a layer name field 511 is provided for entry and/or editing of the name of the new full-layer image 137-n. Also, in some embodiments, a layer relative depth field 513 is provided for entry and/or editing of the relative predominant depth of the new full-layer image 137-n within the composite image 197, e.g., relative to the other full-layer images within the plurality of full-layer images 137-1 to 137-P.

In some embodiments, the layer adding workbench interface 500 includes an add layer control 519 that when activated by the user will cause the system 100 to direct the AI-based composite image generator 151 to integrate the new full-layer image 137-n within the composite image 197. In some embodiments, the layer adding workbench interface 500 includes a cancel control 521 that upon activation directs the system 100 to cancel the adding of the new full-layer image 137-n and revert back to the layer specification workbench interface 300 of FIG. 3. Additionally, in various embodiments, the layer adding workbench controller 167 and the layer adding workbench interface 500 collectively provide for adjustment of one or more of a brightness, a contrast, a color, a name, a depth, a lock status, and a visibility status of the new full-layer image 137-n within the composite image 197.

With reference back to FIG. 1, the control system 159 includes an export controller 169 configured to control exporting of images from the system 100 to image files for storage in digital data storage devices. When the export control 213 of the project workbench interface 200 is activated, the export controller 169 operates to export the image currently displayed within the display area 201 of the project workbench interface 200 to an image file. Also, when the export control 319 of a given layer record 303-x within the layer specification workbench interface 300 is activated, the export controller 169 operates to export the full-layer image 137-x corresponding to the given layer record 303-x to an image file. Also, when the export control 475 of the layer editing workbench interface 400 is activated, the export controller 169 operates to export the image currently displayed within the display area 401 of the layer editing workbench interface 400 to an image file. In some embodiments, the export controller 169 displays an interface through which the user of the system 100 is able to select a particular file format into which the image is to be exported. The system 100 is configurable to export images to essentially any known graphics/image file format. In some embodiments, the base image 113 generated by the system 100 has a unique file format into which the export controller 169 is selectably operable to export an image file. In this manner, an image file exported by the system 100 into the unique file format of the base image 113 can be subsequently loaded into the system 100 for use as the base image 113 of an image composition project.

FIG. 1 also shows that the control system 159 includes a project history controller 171 that is configured to track events performed within the system 100 that affect one or more of the base image 113, the plurality of full-layer images 137-1 to 137-P, and the composite image 197. In some embodiments, the project history controller 171 is configured to store a project record of the base image 113, the plurality of full-layer images 137-1 to 137-P, and the composite image 197 after completion of each event within the system 100 that somehow affects one or more of the base image 113, the plurality of full-layer images 137-1 to 137-P, and the composite image 197.

FIG. 6 shows the project history interface 600, in accordance with some embodiments. In some embodiments, the project history interface 600 shows a number of stored project records for the current image composition project that is loaded and active within the system 100. In some embodiments, each of the stored project records corresponds to a row within the project history interface 600. In some embodiments, each row includes a record identifier column 601 that includes a numeric, alphanumeric, or symbolically unique identifier of the stored project record corresponding to the row. In some embodiments, each row includes a date column 603 and a time column 605 that stores the date and time of creation of the stored project record corresponding to the row. In some embodiments, each row includes an event column 607 that stores a description of the event that occurred within the system 100 to trigger generation of the stored project record corresponding to the row.

In some embodiments, each row includes an actions column 609 that provides a number of user-activatable controls that when activated direct some corresponding action to occur with regard to the stored project record corresponding to the row. In some embodiments, the action column 609 of a given stored project record row includes a “view here” control 611, which when activated by the user will cause the base image 113, the plurality of full-layer images 137-1 to 137-P, and the composite image 197 of the given stored project record row to be loaded by the system 100 as the current versions of the base image 113, the plurality of full-layer images 137-1 to 137-P, and the composite image 197 within the image composition project that is currently active within the system 100. In this manner, by way of the project history controller 171, the “view here” control 611 directs the system 100 to display one or more of the base image 113, the plurality of full-layer images 137-1 to 137-P, and the composite image 197 of a selected stored project record. It should be understood that the “view here” control 611 allows the user to browse through historical states of the image composition project that is currently active within the system 100. It should also be understood that the user can return to the most current state of the image composition project that is currently active within the system 100 by activating the “view here” control 611 in the most recent project record row according to date and time.

In some embodiments, the action column 609 of a given stored project record row includes a “revert to here” control 611, which when activated by the user will revert the current versions of the base image 113, the plurality of full-layer images 137-1 to 137-P, and the composite image 197 within the image composition project that is currently active within the system 100 to the base image 113, the plurality of full-layer images 137-1 to 137-P, and the composite image 197, respectively, of the given stored project record row. It should be understood that the “revert to here” control 613 allows the user to revert (reverse) the image composition project that is currently active within the system 100 to a previously stored state. It should also be understood that the “revert to here” control 613 action causes a new image composition project record to be stored with in the project history. Therefore, activation of the “revert to here” control 613 does not cause loss of previously stored project records within the image composition project that is currently active within the system 100.

In some embodiments, the action column 609 of a given stored project record row includes a “new from here” control 615, which when activated by the user will launch a new image composition project within the system 100 that has the base image 113, the plurality of full-layer images 137-1 to 137-P, and the composite image 197 of the given stored project record row as the current/starting versions of the base image 113, the plurality of full-layer images 137-1 to 137-P, and the composite image 197, respectively, within the new image composition project. When the new image composition project is launched, the project history of the new image composition project is cleared/reset.

FIG. 1 also shows that the control system 159 includes a layer history controller 173 that is configured to track events performed within the system 100 that affect a given one of the full-layer images 137-1 to 137-P. The layer history controller 173 is configured to track layer-level events for each of the full-layer images 137-1 to 137-P. In some embodiments, the layer history controller 173 is configured to store a layer record of the given one of the plurality of full-layer images 137-1 to 137-P after completion of each event within the system 100 that affects the given one of the plurality of full-layer images 137-1 to 137-P.

FIG. 7 shows the layer history interface 700, in accordance with some embodiments. In some embodiments, the layer history interface 700 shows a number of stored layer records for the given full-layer image 137-x of the plurality of full-layer images 137-1 to 137-P. In some embodiments, each of the stored layer records corresponds to a row within the layer history interface 700. In some embodiments, each row includes a record identifier column 701 that includes a numeric, alphanumeric, or symbolically unique identifier of the stored layer record corresponding to the row. In some embodiments, each row includes a date column 703 and a time column 705 that stores the date and time of creation of the stored layer record corresponding to the row. In some embodiments, each row includes an event column 707 that stores a description of the event that occurred within the system 100 to trigger generation of the stored layer record corresponding to the row.

In some embodiments, each row includes an actions column 709 that provides a number of user-activatable controls that when activated direct some corresponding action to occur with regard to the stored layer record corresponding to the row. In some embodiments, the action column 709 of a given stored layer record row includes a “view here” control 711, which when activated by the user will cause the full-layer image 137-x of the given stored layer record row to be loaded by the system 100 as the current version of the full-layer image 137-x within the image composition project that is currently active within the system 100. In this manner, by way of the layer history controller 173, the “view here” control 711 directs the system 100 to display the full-layer image 137-x of a selected stored layer record row. It should be understood that the “view here” control 711 allows the user to browse through historical states of the particular full-layer image 137-x of the image composition project that is currently active within the system 100. It should also be understood that the user can return to the most current state of the particular full-layer image 137-x by activating the “view here” control 711 in the most recent layer record row according to date and time.

In some embodiments, the action column 709 of a given stored layer record row includes a “revert to here” control 713, which when activated by the user will revert the current version of the full-layer image 137-x within the image composition project that is currently active within the system 100 to the full-layer image 137-x of the given stored layer record. It should be understood that the “revert to here” control 713 allows the user to revert (reverse) the particular full-layer image 137-x that is currently active within the system 100 to a previously stored state. It should also be understood that the “revert to here” control 713 action causes a new layer record to be stored within the particular layer history. Therefore, activation of the “revert to here” control 713 does not cause loss of previously stored layer records for the particular full-layer image 137-x within the image composition project that is currently active within the system 100.

In some embodiments, the action column 709 of a given stored layer record row includes a “new from here” control 715, which when activated by the user will launch a new image composition project within the system 100 that has the current/starting version of the base image 113 within the new image composition project set as the full-layer image 137-x of the given stored layer record. When the new image composition project is launched, the layer history of each layer of the new image composition project is cleared/reset.

It should be understood that the system 100 is operable by the user, e.g., designer, to leverage AI-based tools to automatically and/or semi-automatically create the composite image 197 of the virtual asset. In some embodiments, the composite image 197 of the virtual asset, as generated by the system 100, is associated with a computer application, such as a video game. In some embodiments, the composite image 197 corresponds to a graphical scene that is displayed by a computer application. In some embodiments, the composite image 197 corresponds to one or more virtual object(s) that are displayed by a computer application.

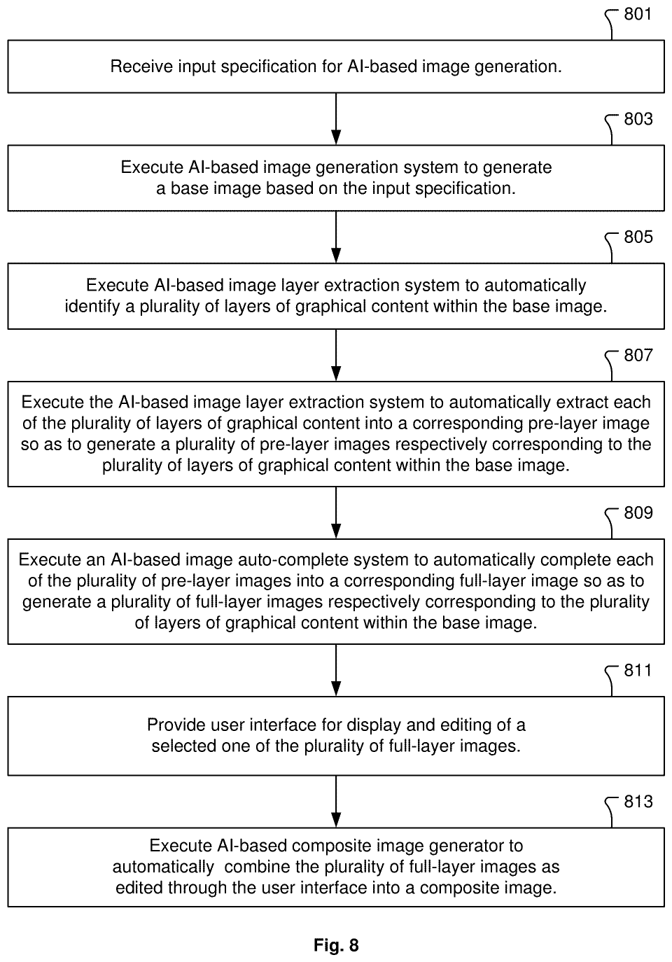

FIG. 8 shows a flowchart of a method for AI-based image generation, in accordance with some embodiments. The method of FIG. 8 corresponds to use of the system 100 to generate the composite image 197. The method includes an operation 801 for receiving the input specification 103 for AI-based image generation. The method also includes an operation 803 for executing the AI-based image generation system 107 to generate the base image 113 based on the input specification 103. In some embodiments, the method includes providing a user interface, e.g., the control 203, for user entry of the input specification 103. The method includes conveying the input specification 103 to the AI-based image generation system 107. The method also includes directing generation of the base image 113 by the AI-based image generation system 107, such as by operation of the control system 159. The method also includes displaying the base image 113, such as within the display area 201.

The method also includes an operation 805 for executing the AI-based image layer extraction system 117 to automatically identify the plurality of layers of graphical content within the base image 113. The method also includes an operation 807 for executing the AI-based image layer extraction system 117 to automatically extract each of the plurality of layers of graphical content into the corresponding pre-layer image 125-x so as to generate the plurality of pre-layer images 125-1 to 125-P, respectively corresponding to the plurality of layers of graphical content within the base image 113. In some embodiments, the method also includes an operation 809 for executing the AI-based image auto-complete system 129 to automatically complete each of the plurality of pre-layer images 125-1 to 125-P into the corresponding full-layer image 137-x so as to generate the plurality of full-layer images 137-1 to 137-P, respectively corresponding to the plurality of layers of graphical content within the base image 113. The method also includes an operation 811 for providing a user interface, e.g., layer editing workbench interface 400, for display and editing of the selected full-layer image 137-x of the plurality of full-layer images 137-1 to 137-P. The method also includes an operation 813 for executing the AI-based composite image generator 151 to automatically combine the plurality of full-layer images 137-1 to 137-P as edited through the user interface, e.g., 400, into the composite image 197.

In some embodiments, the method includes providing a user interface, e.g., layer specification workbench interface 300, for display and control of the plurality of full-layer images 137-1 to 137-P. In some embodiments, the user interface, e.g., 300 and/or 400, includes controls, e.g., 313 and/or 413, for enabling independent display toggling of each of the plurality of full-layer images 137-1 to 137-P within the composite image 197. In some embodiments, the user interface, e.g., 300 and/or 400, includes controls, e.g., 311 and/or 411, for enabling independent modification locking of each of the plurality of full-layer images 137-1 to 137-P within the composite image 197. In some embodiments, the user interface, e.g., 300 and/or 400, includes controls, e.g., 309 and/or 409, for independent specification of a depth for each of the plurality of full-layer images 137-1 to 137-P within the composite image 197.

In some embodiments, the method includes providing the regeneration control 323 within the user interface, e.g., 300. In response to activation of the regeneration control 323, the method includes directing the AI-based image generation system 107 to regenerate each of the plurality of full-layer images 137-1 to 137-P that is not currently modification locked, as indicated in the locked designation column 311 of the layer specification workbench interface 300.

In some embodiments, the method includes providing a user interface, e.g., 300, for user entry of the layer input specification 415. The method also includes conveying the layer input specification 415 to the AI-based image generation system 107. The method also includes directing generation of a new version of the selected one of the plurality of full-layer images 137-x by the AI-based image generation system 107 in accordance with the layer input specification 415. The method also includes displaying the new version of the selected one of the plurality of full-layer images 137-x within the display area 401. Additionally, in some embodiments, the method includes executing the AI-based image refinement system 141 to automatically adjust a realism of a given one of the plurality of full-layer images 137-x in accordance with a relative refinement setting as specified through the layer refinement strength control 419. Also, in some embodiments, the method includes providing for adjustment of a position of the selected one of the plurality of full-layer images 137-x within the composite image 197. In various embodiments, the method includes providing for adjustment of one or more of a brightness, a contrast, a color, a name, a depth, a lock status, and a visibility status of the selected one of the plurality of full-layer images 137-x within the composite image 197.

In some embodiments, the method includes providing a user interface, e.g., layer adding workbench interface 500, for display and adding of a new full-layer image 137-n to the plurality of full-layer images 137-1 to 137-P. In some embodiments, the new full-layer image 137-n is generated by the AI-based image generation system 107. In some embodiments, the method includes providing for user entry of the layer mask specification 507 for spatially controlling implementation of the new full-layer image 137-n within the composite image 197. Also, in various embodiments, the method provides for adjustment of one or more of a brightness, a contrast, a color, a name, a depth, a lock status, and a visibility status of the new full-layer image 137-n within the composite image 197.

In some embodiments, the method includes tracking events performed within the system 100 that affect one or more of the base image 113, the plurality of full-layer images 137-1 to 137-P, and the composite image 197. In these embodiments, the method includes storing a project record of the base image 113, the plurality of full-layer images 137-1 to 137-P, and the composite image 197 after completion of each event. In some embodiments, the method includes enabling the user of the system 100 to select a stored project record, and displaying one or more of the base image 113, the plurality of full-layer images 137-1 to 137-P, and the composite image 197 of the stored project record that is selected by the user. In some embodiments, the method includes enabling the user of the system 100 to select a stored project record, and respectively reverting a current base image 113, a current plurality of full-layer images 137-1 to 137-P, and a current composite image 197 to a previous base image 113, a previous plurality of full-layer images 137-1 to 137-P, and a previous composite image 197 of the stored project record that is selected by the user. In some embodiments, the method includes enabling the user of the system 100 to select a stored project record, and launching a new image composition project within the system 100, wherein a starting base image 113, a starting plurality of full-layer images 137-1 to 137-P, and a starting composite image 197 of the new image composition project are respectively set to a previous base image 113, a previous plurality of full-layer images 137-1 to 137-P, and a previous composite image 197 of the stored project record that is selected by the user.

In some embodiments, the method includes tracking events performed within the system 100 that affect a given full-layer image 137-x of the plurality of full-layer images 137-1 to 137-P. The system 100 separately tracks events that affect each of the plurality of full-layer images 137-1 to 137-P on a layer-by-layer basis. The method includes storing a layer record of the given full-layer image 137-x after completion of each event that affects the given full-layer image 137-x. The method also includes enabling the user to select a stored layer record, and displaying the given full-layer image 137-x of the stored layer record that is selected by the user. In some embodiments, the method includes enabling the user of the system 100 to select a stored layer record for a given full-layer image 137-x, and reverting a current version of the given full-layer image 137-x to a previous version of the full-layer image 137-x corresponding to the stored layer record that is selected by the user. In some embodiments, the method includes enabling the user of the system 100 to select a stored layer record for a given full-layer image 137-x, and launching a new image composition project within the system 100, where the base image 113 of the new image composition project is set to the given full-layer image 137-x of the stored layer record that is selected by the user.

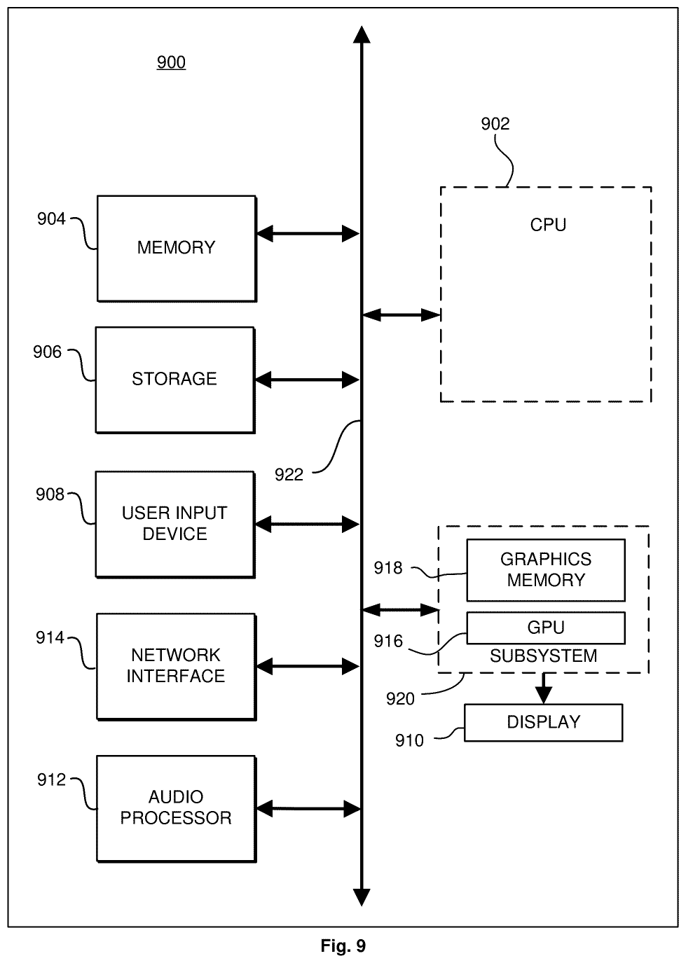

FIG. 9 shows various components of an example server device 900 within a cloud-based computing system that can be used to perform aspects of the system 100 and methods for AI-based image generation as disclosed herein, in accordance with some embodiments. This block diagram illustrates the server device 900 that can incorporate or can be a personal computer, video game console, personal digital assistant, a head mounted display (HMD), a wearable computing device, a laptop or desktop computing device, a server or any other digital computing device, suitable for practicing an embodiment of the disclosure. The server device (or simply referred to as “server” or “device”) 900 includes a central processing unit (CPU) 902 for running software applications and optionally an operating system. The CPU 902 may be comprised of one or more homogeneous or heterogeneous processing cores. For example, the CPU 902 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 900 may be localized to a designer designing a game segment or remote from the designer (e.g., back-end server processor), or one of many servers using virtualization in the cloud-based gaming system 900 for remote use by designers.

Memory 904 stores applications and data for use by the CPU 902. Storage 906 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 908 communicate user inputs from one or more users to device 900, examples of which may include keyboards, mice, joysticks, touch pads, touch screens, still or video recorders/cameras, tracking devices for recognizing gestures, and/or microphones. Network interface 914 allows the device 900 to communicate with other computer systems via an electronic communications network, and may include wired or wireless communication over local area networks and wide area networks such as the internet. An audio processor 912 is adapted to generate analog or digital audio output from instructions and/or data provided by the CPU 902, memory 904, and/or storage 906. The components of device 900, including CPU 902, memory 904, data storage 906, user input devices 908, network interface 914, and audio processor 912 are connected via one or more data buses 922.

A graphics subsystem 920 is further connected with data bus 922 and the components of the device 900. The graphics subsystem 920 includes a graphics processing unit (GPU) 916 and graphics memory 918. Graphics memory 918 includes a display memory (e.g., a frame buffer) used for storing pixel data for each pixel of an output image. Graphics memory 918 can be integrated in the same device as GPU 916, connected as a separate device with GPU 916, and/or implemented within memory 904. Pixel data can be provided to graphics memory 918 directly from the CPU 902. Alternatively, CPU 902 provides the GPU 916 with data and/or instructions defining the desired output images, from which the GPU 916 generates the pixel data of one or more output images. The data and/or instructions defining the desired output images can be stored in memory 904 and/or graphics memory 918. In an embodiment, the GPU 916 includes 3D rendering capabilities for generating pixel data for output images from instructions and data defining the geometry, lighting, shading, texturing, motion, and/or camera parameters for virtual object(s) within a scene. The GPU 916 can further include one or more programmable execution units capable of executing shader programs.

The graphics subsystem 920 periodically outputs pixel data for an image from graphics memory 918 to be displayed on display device 910. Display device 910 can be any device capable of displaying visual information in response to a signal from the device 900, including CRT, LCD, plasma, and OLED displays. In addition to display device 910, the pixel data can be projected onto a projection surface. Device 900 can provide the display device 910 with an analog or digital signal, for example.

Implementations of the present disclosure for the system 100 and methods for AI-based image generation may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although various method operations were described in a particular order, it should be understood that other housekeeping operations may be performed in between the method operations. Also, method operations may be adjusted so that they occur at slightly different times or in parallel with each other. Also, method operations may be distributed in a system which allows the occurrence of the processing operations at various intervals associated with the processing.

One or more embodiments can also be fabricated as computer readable code (program instructions) on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices, or any other type of device that is capable of storing digital data. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

What is claimed is:

1. A system for artificial intelligence (AI)-based interactive virtual asset composition, comprising:
an input processor configured to receive an input specification for AI-based image generation;
an AI-based image generation system configured to generate a base image based on the input specification;
an AI-based image layer extraction system configured to automatically identify a plurality of layers of graphical content within the base image, the AI-based image layer extraction system configured to automatically extract each of the plurality of layers of graphical content into a corresponding pre-layer image so as to generate a plurality of pre-layer images respectively corresponding to the plurality of layers of graphical content within the base image;
an AI-based image auto-complete system configured to automatically complete each of the plurality of pre-layer images into a corresponding full-layer image so as to generate a plurality of full-layer images respectively corresponding to the plurality of layers of graphical content within the base image;
a layer editing workbench controller configured to provide a user interface for display and editing of a selected one of the plurality of full-layer images; and
an AI-based composite image generator configured to automatically combine the plurality of full-layer images as edited by the layer editing workbench controller into a composite image.

2. The system as recited in claim 1, further comprising:
a project workbench controller configured to provide a user interface for user entry of the input specification, the project workbench controller configured to convey the input specification to the AI-based image generation system and direct generation of the base image by the AI-based image generation system, the project workbench controller configured to direct display of the base image.

3. The system as recited in claim 1, further comprising:
a project history controller configured to track events performed within the system for AI-based image generation that affect one or more of the base image, the plurality of full-layer images, and the composite image, the project history controller configured to store a project record of the base image, the plurality of full-layer images, and the composite image after completion of each event.

4. The system as recited in claim 3, wherein the project history controller provides a first control that upon activation displays one or more of the base image, the plurality of full-layer images, and the composite image of a selected stored project record.

5. The system as recited in claim 3, wherein the project history controller provides a second control that upon activation respectively reverts a current base image, a current plurality of full-layer images, and a current composite image to the base image, the plurality of full-layer images, and the composite image of a selected stored project record.

6. The system as recited in claim 3, wherein the project history controller provides a third control that upon activation launches a new project within the system for AI-based image generation respectively having the base image, the plurality of full-layer images, and the composite image of a selected stored project record as a current base image, a current plurality of full-layer images, and a current composite image.

7. The system as recited in claim 1, further comprising:
a layer specification workbench controller configured to provide a user interface for display and control of the plurality of full-layer images, the layer specification workbench controller enabling independent display toggling of each of the plurality of full-layer images, the layer specification workbench controller enabling independent modification locking of each of the plurality of full-layer images, the layer specification workbench controller providing for independent depth specification for each of the plurality of full-layer images within the composite image.

8. The system as recited in claim 7, wherein the layer specification workbench controller includes a regeneration control that upon activation directs the AI-based image generation system to regenerate each of the plurality of full-layer images that is not currently modification locked.

9. The system as recited in claim 7, further comprising:
a layer history controller configured to track events performed within the system for AI-based image generation that affect a given one of the plurality of full-layer images, the layer history controller configured to store a layer record of the given one of the plurality of full-layer images after completion of each event that affects the given one of the plurality of full-layer images.

10. The system as recited in claim 9, wherein the layer history controller provides a first control that upon activation displays the full-layer image of a selected stored layer record.

11. The system as recited in claim 9, wherein the layer history controller provides a second control that upon activation reverts a current full-layer image to the corresponding full-layer image of a selected stored layer record.

12. The system as recited in claim 9, wherein the layer history controller provides a third control that upon activation launches a new project within the system for AI-based image generation having the full-layer image of a selected stored layer record as a base image within the new project.

13. The system as recited in claim 1, wherein the layer editing workbench controller provides a user interface for user entry of a layer input specification, the layer editing workbench controller configured to convey the layer input specification to the AI-based image generation system and direct generation of a new version of the selected one of the plurality of full-layer images by the AI-based image generation system, the layer editing workbench controller configured to direct display of the new version of the selected one of the plurality of full-layer images.

14. The system as recited in claim 13, further comprising:
an AI-based image refinement system configured to automatically adjust a realism of a given one of the plurality of full-layer images in accordance with a relative refinement setting, wherein the layer editing workbench controller includes a refinement control that upon activation directs the AI-based image refinement system to generate a new version of the selected one of the plurality of full-layer images in accordance with a current relative refinement setting for the selected one of the plurality of full-layer images.

15. The system as recited in claim 13, wherein the layer editing workbench controller is configured to provide for adjustment of a position of the selected one of the plurality of full-layer images within the composite image.

16. The system as recited in claim 13, wherein the layer editing workbench controller is configured to provide for adjustment of one or more of a brightness, a contrast, a color, a name, a depth, a lock status, and a visibility status of the selected one of the plurality of full-layer images within the composite image.

17. The system as recited in claim 1, further comprising:
a layer adding workbench controller configured to provide a user interface for display and adding of a new full-layer image to the plurality of full-layer images.

18. The system as recited in claim 17, wherein the layer adding workbench controller provides a user interface for user entry of a layer input specification, the layer adding workbench controller configured to convey the layer input specification to the AI-based image generation system and direct generation of the new full-layer image by the AI-based image generation system, the layer adding workbench controller configured to direct display of the new full-layer image.

19. The system as recited in claim 17, wherein the layer adding workbench controller provides for user entry of a layer mask specification to spatially control implementation of the new full-layer image within the composite image.

20. The system as recited in claim 17, wherein the layer adding workbench controller is configured to provide for adjustment of one or more of a brightness, a contrast, a color, a name, a depth, a lock status, and a visibility status of the new full-layer image within the composite image.

21. A method for artificial intelligence (AI)-based interactive virtual asset composition, comprising:
receiving an input specification for AI-based image generation;
executing an AI-based image generation system to generate a base image based on the input specification;
executing an AI-based image layer extraction system to automatically identify a plurality of layers of graphical content within the base image;
executing the AI-based image layer extraction system to automatically extract each of the plurality of layers of graphical content into a corresponding pre-layer image so as to generate a plurality of pre-layer images respectively corresponding to the plurality of layers of graphical content within the base image;
executing an AI-based image auto-complete system to automatically complete each of the plurality of pre-layer images into a corresponding full-layer image so as to generate a plurality of full-layer images respectively corresponding to the plurality of layers of graphical content within the base image;
providing a user interface for display and editing of a selected one of the plurality of full-layer images; and
executing an AI-based composite image generator to automatically combine the plurality of full-layer images as edited through the user interface into a composite image.
